(19) United States
(12) Patent Application Publication
(10) Pub. No.: US 2002/0161476 A1
(43) Pub. Date: Oct. 31, 2002

(54) System for vending and dispensing digital files

(76) Inventors: David Panofsky, Brooklyn, NY (US); Eric Dahler, Kensington, MD (US)

Correspondence Address: Alan R. Thiele, Jenkens & Gilchrist, P.C., 1445 Ross Avenue, Suite 3200, Dallas, TX, 75202-2799, US

(21) Appl. No.: 10/117,261

(22) Filed: Apr. 5, 2002

Related U.S. Application Data
(60) Provisional application No. 60/282,063, filed on Apr. 5, 2001.

(51) Int. Cl. G06F 17/00

(52) U.S. Cl. 700/231

(57) ABSTRACT

A system and method for the contemporaneous use of a vending machine and host terminal to interact with digital files. Authorized user of the vending machine or host terminal may tap into digital file content such as digital music files, e-mail, personal data or digital files including current information such as meeting schedules, calendars, reminder lists, stock prices, sports scores, and news headlines.

### CROSS-REFERENCE TO RELATED APPLICATION

This application claims the benefit of U.S. provisional patent application serial No. 60/282,063 filed Apr. 5, 2001.

### BACKGROUND OF THE INVENTION 1. Field

The present invention pertains to a system and method for the vending of a physical product and/or dispensing digital files at a single location.

2. Background

Technology exists for connecting vending machines or other host terminals located at kiosks, ATM's, etc., to the Internet to provide inventory/sales data, credit card purchasing information, and Internet based advertising. Despite this use of the Internet with vending machines, there is no system and method available for delivering digital music files, e-mail, and other personal information to vending machines or host terminals. Nor is there a system by which a user interface at a vending machine or other host terminal will provide access by that user to information or data available on a computer network.

### SUMMARY

A system for the contemporaneous sale of physical products and digital files to a purchaser is disclosed which uses a vending machine or host terminal to interface with a purchaser who may also want access to digital files such as digital music files or the internet or personal digital files such as e-mail, or personal calendars, and to-do lists.

The vending machine use of the disclosed system and method is of the type which is generally used to sell products such as soda, food items, or convenience products. When the purchaser initiates the sale of the product, the vending machine queries the purchaser to determine if the purchaser belongs to a recognized set of purchasers, typically called subscribers. If the purchaser belongs to the recognized set of purchasers, the machine enables the logging into a source of digital file content at an interface panel. In addition to dispensing the product purchased by the purchaser, the purchaser may also download digital file content. For example, the purchaser may download digital file content such as digital music files into a digital player or onto loudspeakers located at the vending machine. Alternatively, the purchaser may download e-mail or personal information into a device including a memory and means for manipulating the data such as a personal digital assistant, a cell phone, a digital camera or a handheld computer.

It will be understood that while the foregoing paragraph describes utilization of the system and method of the present invention with a vending machine, those of ordinary skill in the art will understand that the invention may be used with a wide variety of host terminals.

### BRIEF DESCRIPTION OF THE DRAWING FIGURES

A better understanding of the system and method of the present invention may be had by reference to the drawing figures wherein:

FIG. 1 is a flow chart describing the operation of the system and method of the present invention;

FIG. 2 is a perspective view of a vending machine incorporating the system and method of the present invention;

FIG. 3 is an enlarged front elevational view of the user interface portion of the vending machine;

FIG. 3A is a left side elevational view in partial section of the user interface portion of the vending machine;

FIG. 3B is a schematic of a front elevational view of the user interface portion of the vending machine;

FIG. 3C is a right side elevational view in partial section of the user interface portion of the vending machine; and

FIG. 3D is a right side elevational view in partial section similar to the view shown in FIG. 3C but further including a digital music device.

### DESCRIPTION OF THE EMBODIMENTS

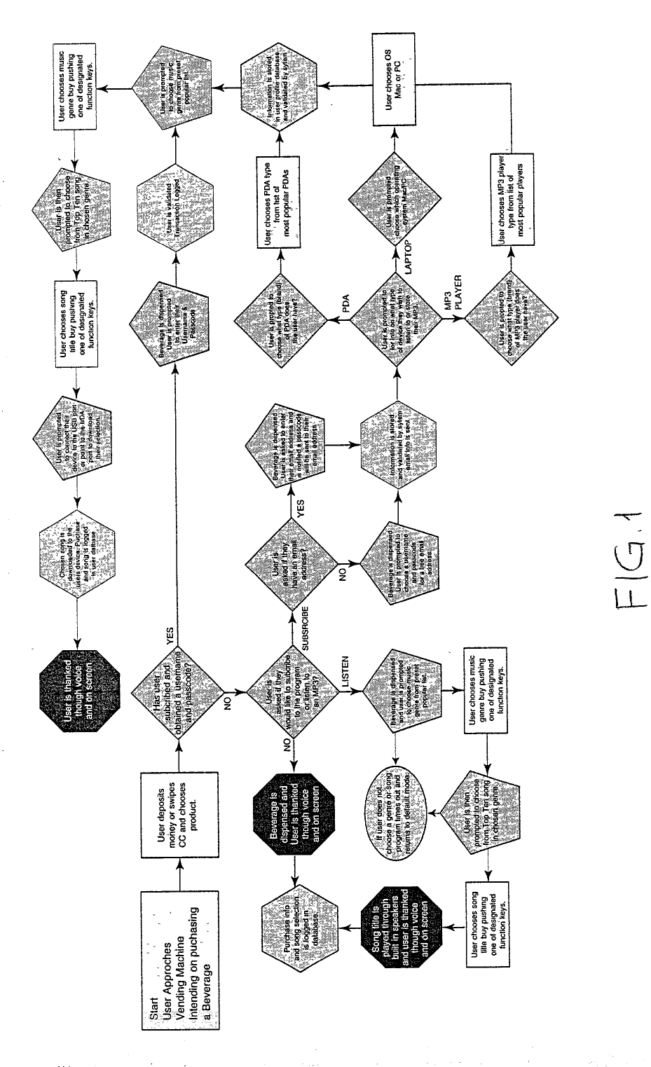

A better understanding of the system and method of the present invention may be had by reference to the flow chart in FIG. 1 which explain the operation of the system and method of the present invention for use with a vending machine. Beginning in the leftmost corner, a user or purchaser approaches the vending machine or host terminal, intent on purchasing a beverage or a physical product, or using a host terminal. Next, the user deposits money into the machine or swipes a credit card and, in the vending machine example, chooses a product. At this point, the machine determines if the user is a subscriber. Specifically, the user is queried to determine membership in an authorized set of system users by a request for a user name and password. If the purchaser's name and password are included in the set of subscribers, a beverage or product is dispensed, and the user or purchaser is then prompted to enter a user name and pass code. Once the user name and pass code is validated, the transaction is logged. Following the logging of the transaction, the user is prompted to choose music from a predetermined list. Once the user has chosen a musical selection, by pushing a designated function key, the user is then prompted to choose additional songs from a chosen music genre. Once the user has chosen a song by pushing a designated function list, the user is prompted to connect his or her music recording and playing device to a port for downloading the selected music. Once the downloading of the digital music files is complete, the purchase is recorded, identification of the downloaded song is logged into a database for recording the musical genre preferences of a particular user, and the transaction is completed by the vending machine with a thank you to the user for the business conveyed by a voice and a message on the screen.

If, however, the user is not an authorized subscriber, the user is asked to become a subscriber or listen to a designated choice of music. If the user decides to join the selected set of subscribers, the first question to the user is whether or not the user has an email address. If the user has an e-mail address, then a product is dispensed, and the user is asked to enter the e-mail address and is then notified that a pass code will be sent to the user at his or her e-mail address. If the user does not have an e-mail address, a beverage or a product is dispensed and the user is prompted to select a user name and pass code for obtaining a free e-mail address. Once the user name and password has been chosen, the information is stored and validated by the system. Following the completion of that transaction, the user is asked about the type of device to be used to download music. If the music is downloaded to a digital music player, the user is asked to choose the brand of digital music player. Once the brand of digital music player is chosen from a list of the most popular brands, the music is downloaded in digital form for play by the user. A similar series of steps occurs if the user downloads personal information to either a laptop or a personal digital assistant.

If, however, the user does not want to subscribe but merely wants to listen to music, the beverage is dispensed and the user is prompted to choose a musical selection from a preset list. Once the musical selection has been chosen, the selected song is played through built-in speakers and the user is thanked for using the machine. If, however, there is no desire to listen to music or subscribe to the service, the beverage or product is dispensed and the user is thanked for the business. Upon completion, the purchase information and any song selection is logged into a database.

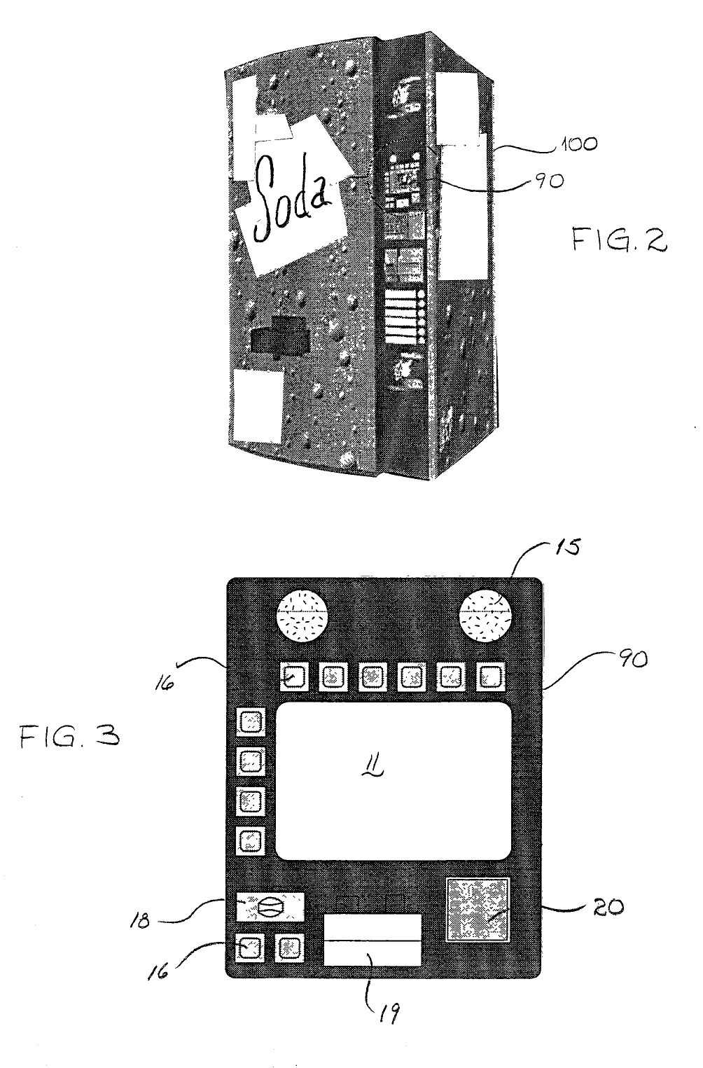

As shown in FIG. 2, the system and method of the present invention is incorporated into a vending machine 100 such as a soda machine. As previously indicated, a vending machine 100 is but one example of a host terminal. User interface is facilitated by use of a panel 90 located on the front of the vending machine 100.

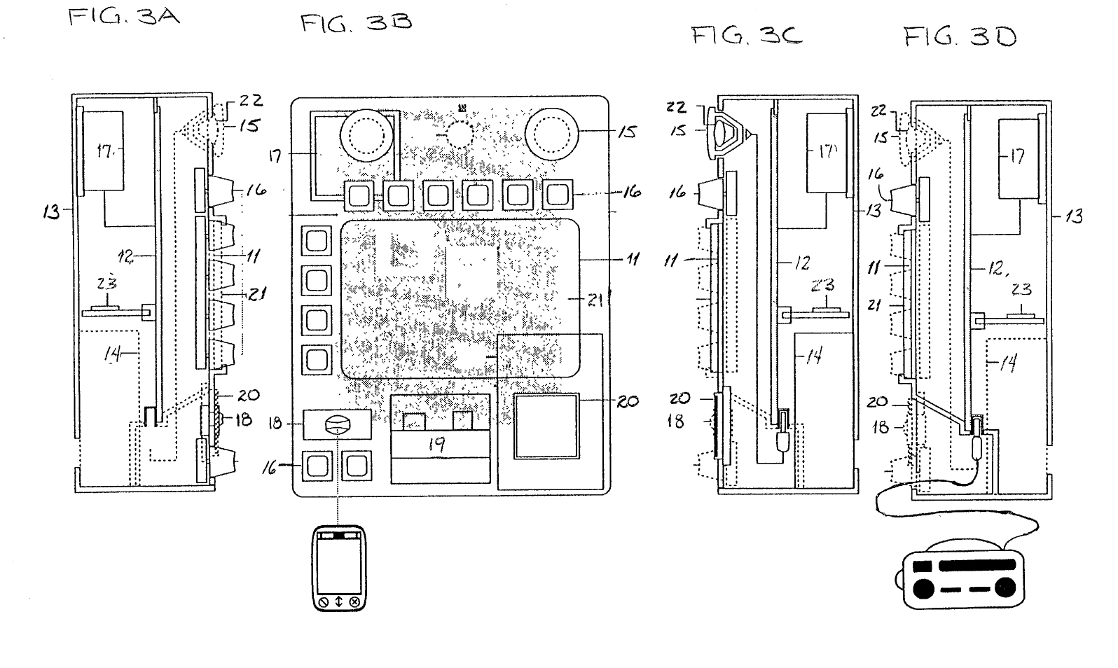

A better understanding of the user interface panel 90 may be had by an understanding of its components. As shown in FIGS. 3, 3A, 3B, 3C, and 3D, in the center portion, is a flat LCD screen 11 which is capable of delivering media and providing an interface for the user into the operating system and various video displays. Protecting the LCD screen is a vandal-proof screen 21.

Behind the graphic user interface is a motherboard 12 including USB serial standard ports, expansion buses, a flat panel display, an IDE, a hard drive interface, audio support, and a solid state memory.

Protecting the motherboard 12 is an aluminum alloy or galvanized steel casing 13 which may include insulation formed from a rubber spray coat or foam.

In the preferred embodiment, a 220 volt power supply 14 with surge protection is used. For playing the music, a 6-watt stereo speaker system 15 is connected to the sound support portion of the motherboard 12.

Standard keyboard function keys 16 are positioned in accordance with the interface on the LCD monitor 11 for user navigation and command control.

A 10 to 20 gigabyte small form factor ID hard drive 17 is used for storing systems software, digital music files, temporary user files, caching, and whatever other files are needed for operation of the system.

A IrDA port 18 for data transfer to and from handheld computing devices and laptop computers is also included.

A recessed USB and serial port 19 provides access for downloading information to handheld digital music players and portable computing devices.

A optional touchpad mouse 20 may also be provided for screen 11 navigation.

A microphone 22 may also be included for recording messages and/or for providing voice recognition commands.

An interface board 23 is also furnished for communication with the vending machine electronics system to track inventory, monitor error conditions, track usage, electronically vend product, and whatever other functions are needed to monitor and control the operation of the vending machine. A riser card may also be used for further expansions of the system, to include the addition of additional modem capability, memory, and power management functions.

The software included with the system includes an error log monitoring capability that is able to report nightly by e-mail to a remote network administrator.

The software system also updates components weekly by checking for new releases of software packages.

A Mozilla browser with a full screen flash player is used to display rich content and web content.

A Debian GNU/Linux desktop operating system is used in the preferred embodiment.

Scripting software which dials into a central computer nightly is used for digital and data content files.

The system also includes commonly available organizer software for recording calendars, address books, e-mails, notebook entries, and the like.

A vendor log monitoring software program is included for recording data usable for market study and inventory control. This software program reports directly to the distributor of the product sold by the vending machine.

The software package also includes sound recording and playback drivers for downloading music to handheld digital music players and laptop computers. Sound playback drivers are also included to play advertisements and voice instructions to users as needed.

Customized interface and promotional program software is also used for custom local and national advertising and market research.

Device synchronization drivers are used to upload or download information to and from the Internet using most any handheld computing devices capable of receiving files in digital form.

Prepayment or micropayment e-commerce capabilities are interfaced with the credit card reader payment system monitoring through interface software with the bill collector and coin collector.

Also included is a database log of all computer activity capable of reporting nightly to a central computer database at the network administrator.

The system and method of the present invention creates a new experience for consumers or purchasers using vending machines 100 or kiosks. According to the present invention, operators of vending machines 100 such as food and beverage companies, as well as purveyors of music and advertisers, will be able to obtain increased revenues.

The system is constructed to deliver preloaded digital music files or other personalized data and digital content such as e-mail messages or short messaging service messages to users of the vending machine 100 or host terminals. When a user purchases a product using the vending machine 100 or interacts with a host terminal, the user will first be queried to determine if the user is a subscriber. Then, if the user is not an authorized subscriber, the user will be prompted to become a member of the set of users who are permitted to gain access to the pervasive computing platform upon which the disclosed system and method is based. Once the user has either joined the set of users allowed access to the pervasive computing platform or is recognized as a user who has access to the pervasive computing platform and is logged into the system, the user will be recognized as a subscriber by any of the vending machines or host terminals using the system and method of the present invention.

In the preferred embodiment, each system, incorporated into a vending machine 100 or host terminal, will electronically store between 20 and 100 popular musical selections in digital form in several music genres. The musical selections stored on the systems at each vending machine 100 or host terminal will vary according to the location or anticipated demography where the vending machine 100 or host terminal is placed. The system in the vending machine 100 or host terminal will also have the ability to automatically suggest genres of music based upon a purchaser's previous selections.

When a purchaser initiates the purchase of a product from a vending machine 100 or initiates the usage of a host terminal by inserting coins, bills, or swiping a credit card, and subsequently logs onto the computer system located at the vending machine or host terminal, the user will be offered a choice of music genre and then a song which may be downloaded onto a handheld digital player via a USB, IrDA, or parallel port connection. Alternatively, the user may listen to the song through loudspeakers built into the vending machine or host terminal itself. The system which provides the digital file content to the user will log all transactions and will actually customize the display of advertising on the screen 11 of the user interface panel 90 according to the demography and location based information associated with a particular vending machine 100 or host terminal. Further, other information such as user preferences, the most popular selections, and loyalty programs to which the user has subscribed, may affect the display on the screen 11 visible to the user.

The digital file dispensing system located at each vending machine 100 or host terminal is remotely maintained from any access point on the Internet through a software based virtual private network. All data traffic to and from the digital file dispensing system at the vending machine 100 or host terminal will be sent through an encrypted and compressed tunnel for higher bandwidth transfers of data and security of digital file transfer within the virtual private network. All transactions, errors in transactions, and processor cycles will be logged and then categorized into a database and transparently uploaded to a central network administrator for maintenance administration and market research. The central network administrator will have the ability to fully upgrade or downgrade each digital file dispensing system at each vending machine 100 or host terminal as needed throughout the analysis of the uploaded system logs and usage databases.

In the illustrated vending machine embodiment, the interface screen 11 will include function keys 16 that correspond with messages appearing on the interface screen 11 and an optional touchpad mouse 20 which will control the purchaser's interaction with the digital file content dispensing system. Voice instructions from the speakers 15 associated with the system and text-based instructions can be displayed on the screen 11 to guide new users through the subscription process, the logon process, the use of e-mail, and the downloading of digital music files. Specific function keys will allow user to navigate through specific websites displayed on screen 11 if desired and promotional content which has been precached into the hard drive portion 17 of the digital file dispensing systems. Vending machines or host terminals having 24-hour DSL, satellite, or Ti line access to the Internet will allow users to actually browse specific websites and download music, video, photos, e-mail or other digital files in real time. Such high bandwidth units will also have the ability to stream live video and music while it is being played at a concert or live commentary from a sporting event when a user actually purchases a beverage and pays specifically for a view of the scheduled live event broadcast contemporaneous with the use of the vending machine or host terminal.

The motherboard 12 for the digital file content dispensing system will include an interface portion that will allow the digital content dispensing system to communicate with the electronics of the vending machine 100 or host terminal to report usage of the vending machine 100 or host terminal, inventory of physical product stored within the vending machine 100 or host terminal, operation of the vending machine 100 or host terminal, payment histories, and error condition alerts to a central location or to the network administrator. This interface with the electronics of the vending machine or host terminal will allow the digital file content dispensing unit to log and characterize usage and demographic user information which can be later used for market research and designing promotional programs to increase sales.

In an additional embodiment of the present invention, the disclosed system and method enables use of the digital file dispensing system at the vending machine 100 or host terminal to be a synchronization point or access point into the pervasive computing platform on which the disclosed system and method is based. Such access will enable the user to gain access to data stored on an on-line account from any system which is connected to the Internet. Accordingly, users who are computer users and eligible subscribers will be able to synchronize data contained on personal information management devices, cellular telephones, digital cameras, handheld computers, and personal digital assistants with their account on a central server in real time while standing at the vending machine 100 or host terminal. Information stored on the pervasive computing platform which enables the operation of the system and method of the present invention will be accessible from any device which is connected to the Internet that uses standard browsing software, so information which is uploaded to an account from the vending machine 100 or host terminal will be accessible from an Internet capable phone, a handheld computer, or traditional personal computer. Based on the preferences set by the purchaser/computer user for access to the pervasive computer platform upon login to the vending machine 100 or host terminal, a display will appear on the user interface screen 11 with personal information such as a number of unread e-mail messages, meetings which have been scheduled for that day/week, reminder/task list, as well as stock portfolios, prices, sports scores, news headlines, or other preselected content needed by the user. Each subscriber account will provide the purchaser with storage space for digital files and other data such as documents and e-mail messages as well as names and phone numbers and a calendar function for listing appointments and dates of events, all of which can be synchronized with databases containing the same files located on the personal computer and/or a handheld organizer such as a palm, a pocket PC computer, or a mobile phone. Alternatively, large files from a handheld device can be quickly uploaded through the vending machine 100 or host terminal using a USB connection 19 or an infrared port 18 and can then be sent from the vending machine 100 or host terminal via the virtual private network on the Internet to the user's account on a central server in times of low network activity. Smaller files, or those files which have not been significantly modified, can be synchronized quickly by either uploading or downloading from the vending machine 100 or host terminal. For example, new e-mail will be downloaded and the new entry in a user's address book will be sent to the user's account while the vending machine or host terminal is being used. In another example, if a meeting has been rescheduled, the calendar displayed on the screen 11 will let the purchaser know about the schedule change and will update the user's personal files. As a synchronization point, the vending machine or host terminal with the digital file dispensing system installed will allow the purchaser to actually hold a handheld computer or device up to an infrared port 18 to quickly synchronize information to and from the handheld device to their on-line account.

Virtual Private Network

The overall architecture of the virtual private network used by the disclosed system and method is composed of several different components: a) the backbone virtual private network, b) the server farm, c) the proxy servers, d) the standalone devices, and e) the legacy gateways.

The backbone virtual private network allows secure communication channels to be opened between servers on the network, authorized subscribers allowed access to use of the network, and, third party clients physically connected by the Internet or other insecure connection means. Through the use of this virtual private network, various protocols and application communication interfaces provide access to the software platform.

The virtual private network itself is made up of three communication layers for allowing access to the software platform from different classes of machines while, at the same time, controlling the appropriate level of security. These three layers of communication are:

(i) Among vending machines or other host terminals such as may be located at a kiosk, an ATM, etc., which communicate with the geographically separated server farms;

(ii) Between the servers connected to the vending machines, other host terminals, and approved third-party clients using industry standard mechanisms; and

(iii) Proxies from the secure environment including the vending machines, other host terminals, and the servers connected thereto out to authenticated, but insecure Internet-connected devices.

First-tier communication between the server farms, the proxy servers, and those systems that are always connected to the network, is handled by encrypted and compressed data tunnels through the Internet. Those systems with only intermittent network connections gain access to the backbone VPN with SSH (www.ssh.com) initiated tunnels. Second-tier IPSec (Internet Protocol Security, an industry-standard VPN protocol) based access to the network is supplied using FreeS/WAN software (www.freeswan.org), allowing non-native and legacy devices secure access to the VPN. Third tier network requests are proxied through a firewall via external web servers to subscribers who are required to access the platform from unsecured systems from time to time.

Virtual Network Computer

The virtual network computer platform provides platform independent and device agnostic access to a user's stored information. This access is accomplished both through use of standard methods (HTML, IMAP, SMTP, etc.) and through the remote frame buffer software virtual network computer. The software, used in the preferred embodiment was originally developed by an AT&T laboratory in the United Kingdom. Specifically, the software allows for the remote control and display of a graphical user environment or desktop. The virtual network computer software works by creating a virtual frame buffer, keyboard and mouse, and then offering this emulated hardware to applications using the standard X11 application programming interface. The current status and changes to the virtual devices are transmitted by a remote frame buffer protocol to a viewer application running on a vending machine or host terminal. The actual mouse, keyboard, and graphics hardware on the system are used for control and display of the remote session, also via the remote frame buffer protocol.

Because all applications are running (and their output being rendered) on the remote server, the specifics of the computer platform at the vending machine or host terminal is irrelevant to the environment. Users can begin working on a project on their home computer, continue working on the project while commuting using their Palm Pilot, and then finish up working on the project on their office PC. A Java version of the client software allows access from all major browsers. The virtual network computer platform of the present invention utilizes an enhanced version of the virtual network computer software which runs with acceptable performance even over low bandwidth lengths with only slight image degradation. The desktop environment of the platform also employs a session management system which allows a user to continue working where the user left off at a different time and/or through a different network access device.

Groupware

A mobile user will not always be able to access the service provided by the disclosed system and method using a virtual private network enabled device, and therefore the disclosed system and method allows access to its groupware applications suite using industry standard network protocols. This service is restricted to those services which can be delivered securely over html and/or WAP such as e-mail and contacts. The disclosed platform will use this method of data delivery for e-mail, web access, user contacts listings, etc. Additionally, a user will be able to use the disclosed method and system of access to the service to manage and configure other parts of his or her subscriber account when sufficient authentication can be provided. Strong cryptographic keys usable on a read-only media are acceptable for this purpose. By extensively utilizing a database-driven, template-based, and dynamically generated system, the interface with the disclosed system and method can be presented in a variety of different languages and styles. Adding a new language simply requires inserting the needed translations into the database.

The Groupware application will include the following productivity tools which are accessible through a variety of network access methods.

Groupware Productivity Applications:

Email

Bookmarks

Address Book

Notes

To Do List

Calendar

File Manager

Applications

Preferences

All of these Groupware Productivity Applications employ mirrored user data that is updated and synchronized each time the user account is accessed. This allows users to have all their personal preferences and information available through any device accessing the system transparently. Users are not required to update, copy, or keep separate copies of vital contact, schedule, email, bookmarks, etc., because the platform integrates all user information into one master platform independent, device agnostic and file-format neutral database.

Logging and Remote Maintenance

Because the disclosed pervasive computer platform will be implemented in a highly distributed fashion with vending machines or host terminals deployed in potentially remote locations, it is necessary to implement a comprehensive logging and maintenance system. For the use of standard UNIX logging mechanism coupled with detailed log scanning software, the disclosed system will alert central systems of local system problems before these problems become catastrophic.

For example, reporting mechanisms which monitor mechanical operation, local to each vending machine 100, constantly monitor the status of the vending machine 100 and report any anomalies. Centralized servers correct the information received from the vending machines and sort it into statistical, diagnostic, maintenance, alert, and intervention level queues. The statistical and diagnostic messages are then automatically processed and entered into databases for later market research and design profiling. Maintenance level messages are often encountered (“housecleaning” level) messages like “disk nearing capacity” or “change receptacle full (on vending models)”. These types of routine problems with vending machines can be managed by a combination of central server initiated software, or routine human (third party) repairs, e.g., a vending machine service person. Intervention and alert level messages which require service personnel to be deployed to an individual vending machine are generally rare. By tracking all problems, but limiting staff intervention to only outstanding problems, a large system can remain secure and functional with minimal cost.

Security Management and Automatic Remote Upgrading

It is well known that regardless of how carefully implemented a system may be, design flaws may still surface. Changes will need to occur at points after the system is deployed, whether for augmentation of an existing feature, deployment of a new feature, or repair of a faulty machine. Of primary concern are issues of security and stability. Updates and fixes are propagated throughout the system in a seamless manner to a variety of different vending machines. Just using end users to maintain security and to apply system stability patches is not a workable solution. For a sufficiently large network, individual attention cannot be given to all the vending machines 100 geographically distributed. The computer platform of the present invention utilizes server mediated remote maintenance for this reason. At regular intervals, all vending machines in the system will check with a central network administrator for system update files. These files will be retrieved, verified for security of origin and content, and applied to the system at each individual vending machine 100. In more than 99% of system modifications, the system at the vending machine 100 will not noticeably change to the end user, and service to the end user will not be interrupted. Occasionally, a device will need to be restarted for a change to take effect. For more urgent software modifications, the patches can be pushed out to the server, and the upgrade will occur immediately. One of the great benefits of the selected Debian GNU/Linux operating system for implementation is its ease of upgradeability and its large number of developers worldwide who are constantly upgrading and enhancing the operating system. New software changes in the architecture of the Debian GNU/Linux operating system will be monitored and deployed to the system at each vending machine 100. Any vending machine 100 which suffers a catastrophic software breakdown reverts to a minimal read-only operation and will then be instructed to reconstruct itself from currently available files hosted on the central network administrator.

Proxy Services

Bandwidth considerations are always a concern when implementing a network architecture. Specifically, bandwidth considerations come into play with network nodes which are only connected by slow dial-up links. Network proxies can be employed to help overcome this problem. The proxy architecture of the present system and method consists of several levels of proxying to provide different types of bandwidth reduction. Much of the content on the Internet is either static or slowly or infrequently changing and is viewed by a large umber of individuals. A caching proxy such as Squid deals best with this type of data. This type of proxy works by saving a copy of any data that passes through it. If, in the future, the same document is requested, the proxy server checks to see if a new version is available. If a new version is not available, the cached copy is sent to the requester. Very little network bandwidth is used in this situation, as the document is loaded only once for several requests.

Caching proxies does not work well for documents that are dynamic or which frequently change. For example, if two requests come into a caching proxy for a document which, among other things, automatically reports the current time, the entire document will need to be loaded both times. Portal sites are dynamic, and therefore are minimally accelerated by caching proxies. For this sort of data, all proxy is used. The proxy in the preferred embodiment is an H-sync (Delta) encoding proxy server. This type of proxy encodes document requests that pass through it in such a way that only actual differences between two versions of the same document will need to be retransmitted if an update is requested. Filtering proxies can also be used to block or modify certain types of documents, or to offload other types of documents to alternate network transmission methods. For example, certain graphics can be blocked or substituted with lower quality ones, and large format documents could be routed to a fax machine. Finally, prefetching and queueing proxies can be used to request documents during times of idleness on the network. Queuing proxies work by requesting documents that will be needed sometime in the future to be downloaded during an off-peak time. When the user next requests the document, this data will reside in the caching proxy for immediate viewing. Pre-fetching proxies work in a similar manner but downloads the documents a user is likely to want (due to an analysis of past sessions) in the idle time of the current session. For example, one's e-mail is downloaded while one's calendar is checked. The pervasive computing platform of the present invention uses queuing and pre-fetching proxies along with demographic data to reduce the waiting time of a user. For example, the system will track the usage pattern of a particular usage of a particular vending machine or host terminal so that requested items can be pre-fetched at or near the time of day that a user typically visits a vending machine or host terminal.

Distributed File System

The pervasive computing platform utilized with the present invention includes a distributed architecture to vastly expand its overall file storage capacity (distributed file system) and to enable participating vending machines or host terminals to handle more computationally demanding applications than they would otherwise be able to handle (distributed processing). The distributed file system works by having individual vending machines or host terminals offer their excess data storage space to the network as a whole. This is accomplished using the Freenet (www.freenetproject.org) protocol that creates a secure, highly replicated, fault tolerant, and server-less file system. Data which is to be stored on the file system is broken into small encrypted chunks which are then replicated and distributed to other participating vending machines or host terminals on the network. When the data is requested, each encrypted chunk is located, retrieved, and replicated before the file is reconstructed and un-encrypted. Data that is requested often becomes highly replicated across the network and, therefore, becomes available with less latency. Because each chunk is encrypted and contains no reference to any other chunk, the raw data of the file system is meaningless without the network as a whole. Therefore, the overall distributed file system remains secure even with some vending machines or host terminals being under the control of third parties.

Distributed Processing

The distributed processing architecture allows one machine to utilize the computation power of many other idle systems on the network without any negative impact on these helper systems. This works by implementing the Cosm (www.mithral.com) protocol that securely allows parts of a program to transparently run across the network on a remote system while the local system gathers and presents the result. For applications which require a computationally intensive algorithm to be applied to a large data set, the work can be widely distributed to many vending machines or host terminals (each responsible only for a small subset of the overall computation) that results in a massive overall speed increase. This distributed processing capability will allow information appliances utilizing the pervasive computing platform portion of the disclosed invention to execute applications that would otherwise be beyond the appliance's on-board processing power. Any of the distributed resources that are in excess of the needs of the pervasive computing platform itself can be offered to other corporate clients or resold to third parties.

Synchronization Services

As the proliferation of information management devices continues, there becomes an increasing need for software which helps to maintain compatibility and coherence between these devices. Also, as users become increasingly more dependent on electronic devices for storage and access to important information, the possibility of catastrophic damage to this information because of device failure becomes greater. The disclosed system and method provides data synchronization services to help eliminate or minimize the effect of these potential problems.

The disclosed system and method is implemented with a number of server-based middle-ware applications which interface with client devices and back-end storage databases to manage the transmission of various types of data. Whenever a client device has the appropriate software installed, the middle-ware software interfaces directly with the client, managing the transfer of information using published protocols and API's. Unfortunately, in many cases, client devices will have either proprietary enclosed data transfer API's or no published API's whatsoever. In some of these instances, platform specific client side software must be written. In other cases, devices will need to access the disclosed system and method in a purely remote access fashion; that is, through the device's browser or through a VNC-based access method. The disclosed pervasive computer platform will be capable of processing, storing, and serving different file types for any given type of information. For example, users may have their address book information on a cellular phone, a Win-CE based personal digital assistant, a Palm OS device, a Mac OS home computer, a Win 95 laptop, and/or a UNIX workstation and may want to merge the data thereon with the information stored on their web-based e-mail account. Once the data is successfully transferred between a client device and the disclosed pervasive computer platform, the data will be translated into an extensible platform neutral format which is then stored in the database. Accordingly, only the middle-ware software will be responsible for data processing, and the data will not suffer from degradation due to conversion.

For an example of degradation, suppose device no. 1 has a middle initial field for a name but has no secondary mail address field, while device no. 2 has a secondary address field but has no middle initial field for a name. If the disclosed computer platform stored address data in either of these device native file formats, some data would be lost in conversion. Because the data template for any class of data is extensible, the database will expand to accept and store new classes of information while any device's data conversation middle-ware piece will be able to serve that device to its fullest potential. In addition to middle-ware capable of supporting various devices, there will be included a software program which presents a user's data in web accessible (html-based) manner, and one which facilitates the implementation of native software client computers which provide access to the computer platform and devices connected into the network.

User Identification

The pervasive computing platform utilizes a number of methods for registering, identifying and authenticating end-users accessing the network from mobile/hand-held devices as well as from stationary PCs and/or vending machines or host terminals. One of the most efficient and secure methods of registering first time and repeat users is through a software program that is used to uniquely and securely identify a user of a vending machine or host terminal or other affiliate devices and point-of-sale systems. Upon a user's first access to the system, a one-time use ID key is created that is algorithmically converted into a valid audio file and transferred onto the user's portable/hand-held device via a USB, infrared or wireless connection. The user can then register by entering a username/email address and the file will be linked to that user during any subsequent use of a vending machine or host terminal that is part of the same network or loyalty program. If a first time user does not have a hand-held device to accept the file, it will be emailed to the customer and can be transferred any time thereafter to a hand-held device via a home or work PC. The user identification software can be utilized in commercial transactions for authentication of legally purchased digital music, video, rich media, and other products and services sold by authorized dealers.

Other forms of user registration and identification include manual data entry of a user name and password into a vending machine or host terminal using navigational buttons provided on the user interface panel. Another form of user registration and identification is voice recognition technology whereby a user speaks his or her ame and/or email address into a vending machine or host terminal with which the system will then send an email to the consumer in order to complete the registration process by acquiring a password through manual data entry at home, work, etc.

Still other methods of user identification may be provided by user. These methods include wireless identification and m-commerce/wireless authentication through mobile phones, radio frequency technology utilizing a transponder device linked to a smart phone and/or key fob type identification/user interface device, and biometric identification methods such as voice-print, fingerprint, or facial recognition systems.

Data Mining (Demographics, Device Utilization, Etc.)

The operating platform software will track usage by each registered end user and will store relevant information in databases that will automatically report to a central server controlled by the host terminal owner/operator. The operating platform software will personalize each user's account, as well as the information presented on the display of the host terminal, to each end user upon login based on their usage and the selections/preferences they set in their account via a web-based account management system. The software operating platform that controls the operation of vending machines and host terminals will be capable of integration with the enterprise automation systems of host terminal owners/operators, allowing them to track usage and implement/administer brand promotions, advertising, and related loyalty programs that award points and related free and/or discounted merchandise to each loyalty program participant.

Wireless Payment Terminal

Also usable with the system and method of the present invention is a modular embedded computing and communications system that is a wireless payment terminal designed for wireless point-of-sale transaction processing in conjunction with wireless phones, hand-held devices, and RFID tokens. This wireless payment terminal is designed to provide reliable data transport and transaction processing services for alternative forms of payment. The wireless payment terminal is similar in appearance to a countertop credit card processing terminal, with additional interfacing capabilities for supporting alternate forms of payment to promote consumer ease of user and end user purchasing convenience. The wireless payment terminal provides a full time wireless connection to a transaction processing center. A per terminal phone line connection is not required.

The wireless payment terminal offers a variety of cashless payment authorization capabilities:

a) RFID devices such as key fobs and wands;

b) Cellular telephones; and

c) Hand-held devices/personal Digital Assistants.

Cellular telephones can communicate with the wireless payment terminals via IrDA or an optional enhanced battery pack with RFID capability. Personal Digital Assistants (PDAs) can communicate with the payment terminal via IrDA, Bluetooth, and/or 802.11b wireless Ethernet.

A larger wireless payment terminal may act as a cell concentrator for other nearby smaller wireless payment terminals to provide full time network connectivity to the smaller wireless payment terminals in a “master/slave” ad hoc network confirmation. Such configuration reduces wireless network communication costs for individual vendors while, at the same time, providing a robust wireless local area network infrastructure that can be expanded upon readily and with minimal integration effort.

Each wireless payment terminal includes a proprietary spread spectrum radio unit designed and developed for ad hoc network connectivity in an FCC tariff and license free band.

An OEM version of the wireless payment terminal can be retrofit into existing vending machines and host terminals such as gasoline pumps, cash registers, vending machines, transit/subway ticketing machines, and ATM kiosks.

Transaction Messaging Protocol

Also provided is a transaction messaging protocol that provides a highly secure encrypted transport layer which provides the ability to support connectivity for higher security applications such as automatic teller machines and gaming terminals such as slot machines. The transaction messaging protocol includes support for multiple types of end user connectivity, including (but not limited to): Bluetooth, 802.11a/b/g, infrared/IrDA, RFID, smart card and magnetic stripe readers. Additionally, the transaction messaging protocol provides a security framework based on strong encryption standards, secure message digest algorithms, and a public key infrastructure which protects sensitive information en route to the payment processing center.

Those of ordinary skill in the art will understand that while the disclosed system and method have been described according to its preferred embodiment, still other embodiments have been enabled by the foregoing disclosure. Such other embodiments shall be included within the scope and meaning of the appended claims.

I claim:

1. A system for improving user usage of a vending machine or host terminal, said system comprising:
a vending machine or host terminal constructed and arranged to interact with a user;
means for recognizing a set of users;
means for logging a recognized user in said set of users into a source of digital file content at a time contemporaneous with the use of said vending machine or host terminal; and
means for downloading said digital file content into a format usable by said user.

2. The system as defined in claim 1 wherein said digital file content is digital music files.

3. The system as defined in claim 2, wherein said user may select specific music within said digital music files.

4. The system as defined in claim 3 wherein said music is played on loudspeakers at said vending machine.

5. The system as defined in claim 3, wherein said selected music is downloaded to a device constructed and arranged for storing and later playing digital music files.

6. The system as defined in claim 1, wherein said digital file content is e-mail.

7. The system as defined in claim 6, wherein said e-mail is in a format which is downloadable into a computer.

8. The system as defined in claim 1, wherein digital file content is personal data.

9. The system as defined in claim 8 wherein said personal data is in a format that is downloadable into a computer.

10. The system as defined in claim 1 further including means for uploading information into said source of digital file content.

11. The system as defined in claim 1 wherein the operation of said vending machine or host terminal, said means for recognizing a user in a set of users, said means for logging a user into a source of digital file content, and said means for downloading said digital file content are tracked by a network administrator.

12. The system as defined in claim 11, wherein said network administrator further includes means for upgrading or downgrading services provided by said vending machine or host terminal.

13. The system as defined in claim 1, wherein said means for downloading said digital file content further includes means for browsing Internet websites.

14. The system as defined in claim 1, wherein said means for downloading said digital file content further includes means for synchronizing data files incorporated into a device selected from a group including a personal digital assistant, a cell phone, a digital camera, and a handheld computer.

15. The system as defined in claim 1, wherein said digital file content is selected from a group including meeting schedules, calendars, reminder lists, stock prices, sports scores, and news headlines.

16. The system as defined in claim 1, wherein said means for downloading said digital file content further includes an infrared port.

17. The system as defined in claim 1, further including means by which a user may enter said set of users recognized by said means for recognizing a set of users.

18. A method for allowing a user the contemporaneous use of a vending machine and host terminal to interact with digital files, said method comprising the steps of:
initiating the use of a vending machine or a host terminal by a user;
recognizing said user as belonging to a set of users;
logging said recognized user into a source of digital file content; and
downloading said digital file content into a format usable by said user.

19. The method as defined in claim 18, wherein said digital file content is digital music files.

20. The method as defined in claim 19, wherein said user may select specific music within said digital music files.

21. The system as defined in claim 20, wherein said music is played on loudspeakers at said vending machine.

22. The system as defined in claim 20, wherein said music is downloaded to a device constructed and arranged for storing and later playing digital music files.

23. The system as defined in claim 18, wherein said digital file content is e-mail.

24. The system as defined in claim 23, wherein said e-mail may be downloaded into a computer.

25. The system as defined in claim 18, wherein said digital file content is personal data.

26. The system as defined in claim 25, wherein said personal data may be downloaded into a computer.

27. The system as defined in claim 18, wherein the operation of the vending machine, the recognition of the user, the logging of a purchaser into a source of digital file content, and the downloading of said digital file content are tracked by a network administrator.

28. The method as defined in claim 27, wherein the network administrator includes means for upgrading or downgrading services provided by said vending machine or host terminal.

29. The method as defined in claim 18, wherein said means for downloading said digital file content further includes means for browsing websites on the Internet.

30. The system as defined in claim 18, wherein said means for downloading further includes means for synchronizing data files incorporated into a device selected from a group including a personal digital assistant, a cell phone, a digital camera, and a handheld computer.

31. The system as defined in claim 18, wherein said digital file content is selected from a group including meeting schedules, calendars, reminder lists, stock prices, sport scores, and news headlines.

32. The system as defined in claim 18 wherein said downloading of said digital file content includes the use of a infrared port.

33. The method as defined in claim 18, further including means by which a user may enter said set of users recognized by said means for recognizing a set of purchasers.

34. The method as defined in claim 18 further including the step of uploading information into said source of digital file content.
